(19) United States
(12) Patent Application Publication
(10) Pub. No.: US 2021/0044629 A1
(43) Pub. Date: Feb. 11, 2021

(54) Quick Determination of the availability of a communication path between UEs and IMS

(71) Applicant: Telefonaktiebolaget LM Ericsson (publ), Stockholm (SE)

(72) Inventors: Magnus HALLENSTÅL, TÄBY (SE); Ester GONZALEZ DE LANGARICA, STOCKHOLM (SE)

(21) Appl. No.: 16/979,726

(22) PCT Filed: Mar. 12, 2018
(86) PCT No.: PCT/SE2018/050237

§ 371 Date: Sep. 10, 2020

(51) Int. Cl. H04L 29/06; H04L 29/12

(52) U.S. Cl. CPC H04L 65/1069; H04L 61/2007; H04L 61/6095; H04L 65/1033; H04L 65/1016

(57) ABSTRACT

A method of operating a Proxy Call Session Control Function, P-CSCF, of an IP Multimedia Subsystem network. The method comprises maintaining a counter for each of a plurality of IP address domains containing IP addresses reachable via the P-CSCF, each IP address domain being associated with one of a plurality of packet gateways. A counter is updated in the event of the failure to deliver a SIP request to a User Equipment, UE, associated with an IP address within the associated IP address domain, at least until the counter reaches a predefined threshold. In the event that a counter reaches a predefined threshold, the P-CSCF responds to a received IMS request addressed to an IP address within the associated IP address domain by returning an indication that the associated terminating UE is unreachable.

### TECHNICAL FIELD

The present invention relates to method and apparatus for quickly determining at a P-CSCF the availability of a communication path between the P-CSCF and a UE in an IP Multimedia Subsystem network. The method and apparatus are applicable in particular to the case where a P-CSCF receives an incoming request addressed to a terminating UE and, for some reason, the path to the UE is down.

### BACKGROUND

IP Multimedia services provide a dynamic combination of voice, video, messaging, data, etc. within the same session. By growing the number of basic applications and the media that it is possible to combine, the number of services offered to the end users will grow, and the inter-personal communication experience will be enriched. This will lead to a new generation of personalised, rich multimedia communication services.

IP Multimedia Subsystem (IMS) is the technology defined by the Third Generation Partnership Project (3GPP) to provide IP Multimedia services over mobile communication networks (3GPP TS 24.229). IMS provides key features to enrich the end-user person-to-person communication experience through the use of standardised IMS Service Enablers, which facilitate new rich person-to-person (client-to-client) communication services as well as person-to-content (client-to-server) services over IP-based networks. The IMS makes use of the Session Initiation Protocol (SIP) to set up and control calls or sessions between user terminals (or user terminals and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly. IMS services are enabled by so-called Application Servers (ASs). An AS may for example provide video conference calls to a group of users connected to the IMS via respective User Equipments (UEs), e.g. mobile phones, laptops etc.

Within the IMS it is the Proxy-Call Session Control Function (P-CSCF) that is the entry and exit point between the UE and the IMS and as such serves as the proxy server for the UE. The UE communicates with the P-CSCF to perform IMS registrations and initiate SIP sessions. The P-CSCF may be in the home domain of the IMS operator, or it may be in a visiting domain where the UE is currently roaming. For registration to a given P-CSCF, the UE performs the P-CSCF discovery procedures. Discovery of a P-CSCF is necessary for the UE to allow it to initiate IMS registrations and sessions.

It will of course be appreciated that a UE must first have a packet switched connection before it can connect and register to the P-CSCF and make use of IMS services. In the case where the access network for the UE is a cellular network offering packet switches services, e.g. a 4G network (an EPS, Evolved Packet Switched network), packet switched access requires the setting up of an EPS bearer between the UE and a Packet Gateway (PGW). The PGW is responsible for allocating an IP address to the UE. In the case of IPv4, the PGW will allocate IP addresses from one or more subaddresses, i.e. a UE will get an IPv4 address within the subaddress for a given APN controlled by the PGW. In the case of IPv6, the PGW has available one or more IPv6 routing prefixes and a UE will get an IPv6 routing prefix controlled by the PGW for a given APN. The IPv6 routing prefix and the UE's interface identifier is combined to obtain a full IPv6 address. In 5G networks the functionality of the PGW is replaced by a pair of nodes, namely the Session Management Function (SMF) and a User Plane Function (UPF). It is the SMF that is responsible for allocating IP addresses to UEs in the same way that the PGW does for 4G.

Occasionally the path via which IP packets are routed between the P-CSCF and a UE, specifically the path between the P-CSCF and the PGW/SMF, can go down. This could be due to interface problems in the respective nodes or in routers and switches between the nodes, or to a cable problem, power outage, etc. It would be advantageous for the P-CSCF to be aware of this when it receives a SIP request destined for a UE, in order to avoid delay in notifying the originating side of the UE's unreachability via the PS network. The rest of the IMS may at this point direct the call to a Circuit Switched (CS) access network or trigger a refresh of the IMS PDN connection.

Current standards provide for a mechanism where the PGW (4G) may send a “ping” message to the P-CSCF to see if the P-CSCF is alive. One option is for the P-CSCF to use the receipt, or absence of receipt, of these pings to determine whether or not the PGW is alive, i.e. if no pings are received by the P-CSCF the PGW is assumed to be down. However, not all available PGWs implement the ping mechanism. Furthermore, in some cases a ping may follow a different path from that followed by IP traffic between the UE and the P-CSCF (due to the PGW using a different router interface for control plane packets) so the receipt or absence of a ping may not be indicative of whether the PGW is up or down for UE traffic. It will also be appreciated that the ping is indicative of the availability of the control plane rather than the user plane and that the former may be up whilst the latter is down.

### SUMMARY

According to a first aspect of the present invention there is provided a method of operating a Proxy Call Session Control Function, P-CSCF, of an IP Multimedia Subsystem network. The method comprises maintaining a counter for each of a plurality of IP address domains containing IP addresses reachable via the P-CSCF, each IP address domain being associated with one of a plurality of packet gateways. A counter is updated in the event of the failure to deliver a SIP request to a User Equipment, UE, associated with an IP address within the associated IP address domain, at least until the counter reaches a predefined threshold. In the event that a counter reaches a predefined threshold, the P-CSCF responds to a received IMS request addressed to an IP address within the associated IP address domain by returning an indication that the associated terminating UE is unreachable.

Upon receipt of a SIP request addressed to an IP address within an associated IP address domain for which no counter currently exists, the P-CSCF establishes a counter for that domain and updates the counter.

One or more of said packet gateways may utilize IPv4, and said IP address domains associated with those packet gateways are respective IPv4 subaddresses. In this case, for each available packet gateway utilising IPv4, the P-CSCF is preconfigured with the lowest subaddress level that IPv4 addresses are allocated from by the packet gateway.

One or more of said packet gateways may utilize IPv6 and said IP address domains associated with those packet gateways are defined by respective, different, 64-bit network prefixes.

Upon receipt of a SIP message at the P-CSCF from a UE, the P-CSCF may determine whether or not the UE is allocated an IP address within an IP address domain for which a counter has reached a predefined threshold and, if yes, then the P-CSCF resets the counter. If not, the P-CSCF takes no action with regard to any associated counter.

Failure to deliver a SIP request may indicated by expiry at the P-CSCF of a T2 timer.

The method may comprise starting a timer, Tx, at the P-CSCF upon sending of a SIP request to a UE, the timer having a predefined expiry value, subsequently receiving a SIP BYE from the sender of the SIP request and, if at that time the timer, Tx, has expired, using this as an indication of failure to deliver the SIP request.

According to a second aspect of the present invention there may be provided an apparatus configured to operate as a Proxy Call Session Control Function, P-CSCF, within an IP Multimedia Subsystem network. The apparatus is configured to maintain a counter for each of a plurality of IP address domains containing IP addresses reachable via the P-CSCF, each IP address domain being associated with one of a plurality of packet gateways, and update a counter in the event of the failure to deliver an SIP request to a User Equipment, UE, associated with an IP address within the associated IP address domain. The apparatus is further configured, in the event that a counter reaches a predefined threshold, to respond to a received IMS request addressed to an IP address within the associated IP address domain by returning an indication that the associated terminating UE is unreachable.

The apparatus may be configured, upon receipt of a SIP request addressed to an IP address within an associated IP address domain for which no counter currently exists, to establish a counter for that domain and update the counter.

Where one or more of said packet gateways utilize IPv4, and said IP address domains associated with those packet gateways are respective IPv4 subaddresses, the apparatus may be preconfigured to store the lowest subaddress level that IPv4 addresses are allocated from by the packet gateway.

The apparatus may be configured, upon receipt of a SIP message at the P-CSCF from a UE, to determine whether or not the UE is allocated an IP address within an IP address domain for which a counter has reached a predefined threshold and, if yes, then reset the counter and, if not, take no action with regard to any associated counter.

The apparatus may be configured to indicate failure to deliver a SIP request by expiry of a T2 timer.

The apparatus may be configured to start a timer, Tx, upon sending of a SIP request to a UE, the timer having a predefined expiry value, subsequently receive a SIP BYE from the sender of the SIP request and, if at that time the timer, Tx, has expired, use this as an indication of failure to deliver the SIP request.

### BRIEF DESCRIPTION OF THE DRAWINGS

FIG. 1 illustrates schematically various entities with a communication network comprising an IMS network;

FIG. 2 is a flow diagram illustrating a method of handling a SIP INVITE at a P-CSCF;

FIG. 3 is a flow diagram illustrating a method of determining, at a P-CSCF, that a link to a PGW is up;

FIG. 4 is a flow diagram illustrating a method of establishing and maintaining a PGW blacklist and PGW blacklist counters, at a P-CSCF; and

FIG. 5 is a block diagram illustrating functional components of a P-CSCF required to implement the methods of FIGS. 2 to 4.

### DETAILED DESCRIPTION

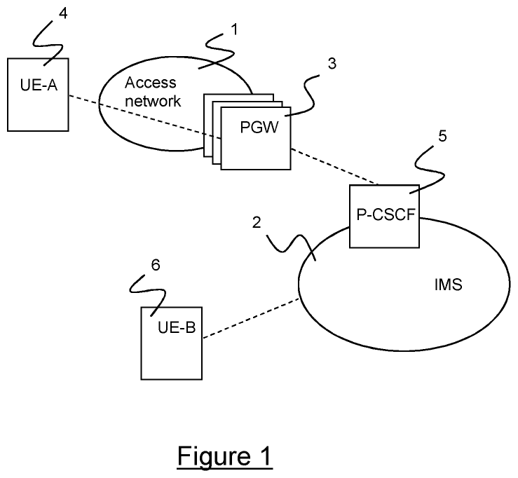

FIG. 1 illustrates schematically certain (functional) entities within a communication network comprising an access network 1 and an IP Multimedia Subsystem (IMS) network 2. In this example the access network 1 is a 4G cellular network comprising a plurality of Packet Data Network Gateways (PDN Gateways or PGWs) 3. The PGWs provide connectivity from User Equipments (UEs) to external packet data networks by being the point of exit and entry of traffic for the UE. Of particular interest here is the role of the PGWs in providing access for UEs to the IMS network 2.

A PGW 3 is allocated a range of IP addresses that it is able to allocate to UEs. In the case of IPv4, this range will be one or more IP subaddress range(es). In the case of IPv6, the range will be defined by one or more 64-bit network prefixes. For the sake of simplicity the remainder of this description will refer to an “IP address domain” to identify the range of IP addresses allocated to a given PGW. When a UE, such as UE-A 4 in FIG. 1, wishes to establish a PS connection it will send a message to a PGW 3 requesting a PDN connection, whereupon the PGW 3 will allocate an address to the UE 4, from its own allocated IP address domain, and establish the PDN connection. Assuming that the UE 4 wishes to access IMS services, the UE will register with the IMS network via the PDN connection, including registering with a P-CSCF 5. Following IMS registration the UE 4 can make use of IMS services including, for example, making and receiving voice calls.

In the event that a packet link between the P-CSCF 5 and a PGW 3 goes down, it will of course not be possible to send packets between UEs connected to the PGW and the P-CSCF, in either direction. However, as discussed above, prior art approaches would make it unlikely that the P-CSCF would be aware of the link status. In the case of a SIP request sent towards UE-A 4, e.g. a SIP INVITE sent from a peer entity such as UE-B 6 in FIG. 1 (in FIG. 1 the access network for UE-B is not shown), the P-CSCF would attempt to send the request on to UE-A. Eventually a delivery timer, SIP T2, will time out. In the case of TCP transport of the IMS message, the IMS will trust that TCP will resend the message according to TCP re-transmission policies. In the case of UDP transport, the IMS stack in the P-CSCF will resend the IMS message after T1=2 seconds; if no response is received the IMS stack will try again after 2*T1, then after 4*T1, etc and the P-CSCF will return a SIP message towards the peer entity to indicate that UE-A is unreachable. However, since T2 timer is 32 seconds long, it is unlikely that the T2 timer times out before the calling party hangs up.

In order to mitigate this problem it is proposed here to provide a means for the P-CSCF to aggregate request delivery failures for all UEs registered in a certain IP domain and to use the result as an indication that communication to that IP domain is down. It can then add the IP domain to a blacklist to prevent further attempts to send requests to UEs within that IP domain until such time as the link is determined to be up again.

In the case of PGWs utilising IPv4, the P-CSCF is preconfigured with the lowest level IP subaddress from which PGWs allocate IP addresses to UEs. When the P-CSCF determines that an attempt to deliver a SIP request to a UE has failed, i.e. there is no response from the UE, the P-CSCF determines which IP subaddress the UE belongs to and determines whether or not a blacklist counter exists for the IP subaddress. If a counter does exist, then the counter value is incremented. [NB. It will be appreciated that the counter may be a counter that counts down rather than up, and that the term “incremented” encompasses the subtraction of a value from the counter.] If a counter does not exist, then one is established and the counter value incremented.

The P-CSCF therefore creates and maintains a new blacklist counter for each potentially faulty IP subaddress. Once a blacklist counter reaches a configured threshold, the P-CSCF assumes the subaddress is not reachable (thus if a PGW is faulty, all subaddresses controlled by this PGW will soon be marked as not reachable) and the subaddress(es) controlled by the PGW added to a blacklist. When the P-CSCF has marked a subaddress as not reachable, it will immediately respond to any request targeted to a UE with an IP address within this subaddress with an appropriate rejection code. No attempt is made by the P-CSCF to deliver the SIP request to the target UE. [NB. The counter may continue to be incremented when further SIP requests are received by the P-CSCF targeted to UEs at the blacklisted subaddress/PGW, or the counter may not be incremented beyond the threshold.]

In order to determine if a previously faulty link is up again, or if a potentially faulty link is actually up, the P-CSCF looks for SIP messages originating from UEs with an IP address in a certain subaddress for which there is a blacklist counter associated with that subaddress. If such a message is received by the P-CSCF then the P-CSCF deletes the blacklist counter (regardless of whether or not the counter has exceeded the predefined threshold) and, if the subaddress is already on the blacklist, deletes the subaddress from the blacklist.

The approach for PGWs implementing IPv6 is very similar. However, as different IPv6 PGWs are associated with one or more unique 64-bit network prefixes, there is no need for any prior configuration of subaddress levels at the P-CSCF. If a UE fails to respond to an attempt to deliver a SIP request to it, the P-CSCF determines which IPv6 64-bit network prefix the UE belongs to, and increments, or creates and increments, a blacklist counter for that prefix. The P-CSCF therefore maintains a blacklist counter for each potentially faulty IPV6 64-bit network prefix. If a counter reaches a configured threshold, the P-CSCF assumes that IPV6 64-bit network prefix is not reachable and adds the network prefix to a blacklist. For network prefixes on the blacklist, the P-CSCF will immediately respond to any request targeted to a UE with an IP address with this IPV6 64-bit network prefix, with an appropriate reject code.

As with the IPv4 implementation, if the P-CSCF receives any SIP message from a UE with an IP address with a certain a IPV6 64-bit network prefix and there is a blacklist counter associated with that IPV6 64-bit network prefix, the blacklist counter is deleted. If the network prefix is also on the blacklist, it will be deleted from the blacklist.

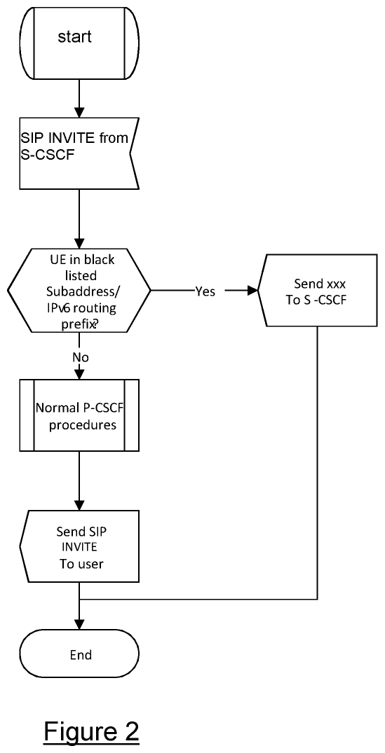

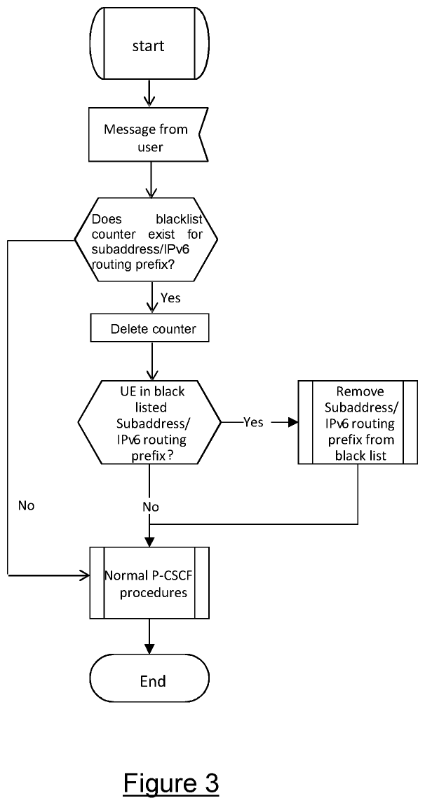

FIG. 2 is a flow diagram illustrating the mechanism for handling incoming SIP requests, such as a SIP INVITE forwarded by an S-CSCF, at a P-CSCF. As discussed, if the request matches a subaddress or IPv6 routing prefix in the blacklist, an unreachable message, for example SIP 503 Service Unavailable, or some other appropriate response code is returned to the S-CSCF; otherwise normal P-CSCF procedures are followed. FIG. 3 is a flow diagram illustrating the procedure which allows a counter to be cancelled in the event that a SIP message is received from a UE having an IP address associated with a counter. In the event that the subaddress/IPv6 routing prefix is also blacklisted, then it is removed from the blacklist.

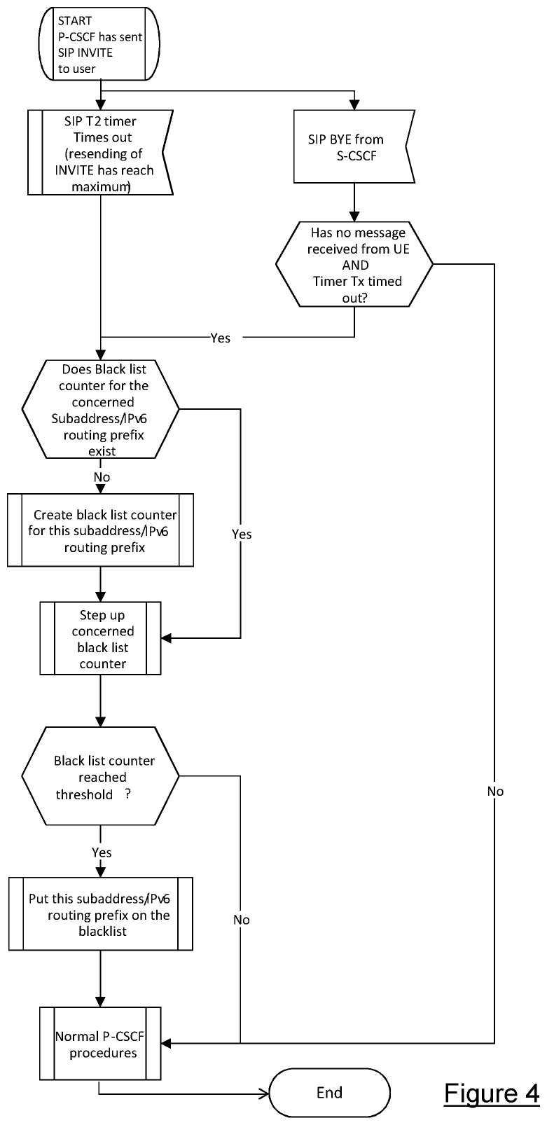

FIG. 4 is a flow diagram illustrating the mechanisms for establishing and maintaining the blacklist counters and the blacklist. As discussed above, the mechanism relies on two timers, a first, existing timer T2 that times out following failure to deliver a SIP request and a second, new timer Tx that times out after some predefined time (less than T2). If timer Tx expires without the calling party having “hung-up”, this is also taken as an indication of the unreachability of the target UE. Tx is introduced since the normal behaviour of a calling party is to hang up if no (ringing) response is received within some short time period, and in most situations a calling user would “hang up” before T2 times out. Thus T2 alone cannot be used as an indication of the unreachability of a UE. Both branches of the flow are therefore used to indicate unreachability and can result in establishment/incrementing of a blacklist counter.

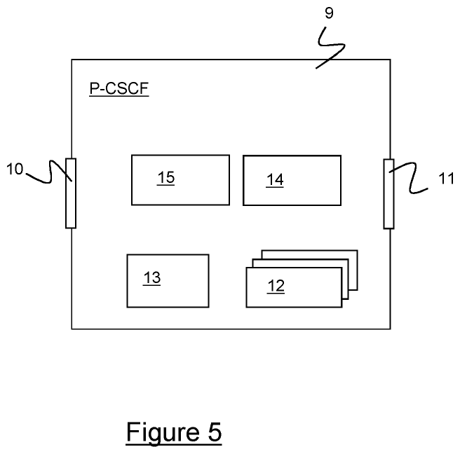

FIG. 5 illustrates an apparatus 9 configured to operate as a P-CSCF in an IMS network. The apparatus comprises appropriate processors and data and software memories, as well as other hardware components, that are configured to implement the functionality described above including certain prior art P-CSCF functions. Of relevance here are an interface 10 for exchanging IP packets with PGWs and an interface 11 for exchanging IP packets with other IMS entities including S-CSCFs. The apparatus is configured to dynamically implement one or more blacklist counters 12 and a blacklist 13. The counters are established and maintained by a processing function 14, which is also responsible for determining when a counter value exceeds a predefined threshold and adding an IP subaddress/network prefix to the blacklist. The same processing function 12 is also configured to delete counters and blacklist entries if an uplink message corresponding to a counter/blacklist subaddress/network prefix is received. A further processing function 15 examines downlink SIP requests to determine whether or not they are directed to a UE having an IP address matching a blacklisted subaddress or network prefix and for either returning an unreachable response or performing normal P-CSCF functions.

It will be appreciated that a P-CSCF may deal with a mix of IPv4 and IPv6 PGWs. In this case the P-CSCF may implement both of the approaches described above in parallel.

It will be appreciated that packet gateway may be a 5GS SMF with an associated UPF or a 3GPP GGSN, and that both cellular and WiFi radio accesses may be connected to said packet gateway.

It will be appreciated by the person of skill in the art that various modifications may be made to the above described embodiments without departing from the scope of the present invention.

1. A method of operating a Proxy Call Session Control Function, P-CSCF, of an IP Multimedia Subsystem network, the method comprising:
maintaining a counter for each of a plurality of IP address domains containing IP addresses reachable via the P-CSCF, each IP address domain being associated with one of a plurality of packet gateways;
updating a counter in the event of the failure to deliver a SIP request to a User Equipment, UE, associated with an IP address within the associated IP address domain, at least until the counter reaches a predefined threshold; and
in the event that a counter reaches a predefined threshold, responding to a received IMS request addressed to an IP address within the associated IP address domain by returning an indication that the associated terminating UE is unreachable.

2. A method according to claim 1, wherein said SIP request is a SIP INVITE.

3. A method according to claim 1 and comprising, upon receipt of a SIP request addressed to an IP address within an associated IP address domain for which no counter currently exists, establishing a counter for that domain and updating the counter.

4. A method according to claim 1, wherein one or more of said packet gateways utilize IPv4, and said IP address domains associated with those packet gateways are respective IPv4 subaddresses.

5. A method according to claim 4 and comprising, for each available packet gateway utilising IPv4, preconfiguring the P-CSCF with the lowest subaddress level that IPv4 addresses are allocated from by the packet gateway.

6. A method according to claim 1, wherein one or more of said packet gateways utilize IPv6 and said IP address domains associated with those packet gateways are defined by respective, different, 64-bit network prefixes.

7. A method according to claim 1, comprising, upon receipt of a SIP message at the P-CSCF from a UE, determining whether or not the UE is allocated an IP address within an IP address domain for which a counter has reached a predefined threshold and, if yes, then resetting the counter and, if not, taking no action with regard to any associated counter.

8. A method according to claim 1, wherein failure to deliver a SIP request is indicated by expiry at the P-CSCF of a T2 timer.

9. A method according to claim 1, comprising starting a timer, Tx, at the P-CSCF upon sending of a SIP request to a UE, the timer having a predefined expiry value, subsequently receiving a SIP BYE from the sender of the SIP request and, if at that time the timer, Tx, has expired, using this as an indication of failure to deliver the SIP request.

10. Apparatus configured to operate as a Proxy Call Session Control Function, P-CSCF, within an IP Multimedia Subsystem network, the apparatus being configured to:
maintain a counter for each of a plurality of IP address domains containing IP addresses reachable via the P-CSCF, each IP address domain being associated with one of a plurality of packet gateways;
update a counter in the event of the failure to deliver an SIP request to a User Equipment, UE, associated with an IP address within the associated IP address domain; and
in the event that a counter reaches a predefined threshold, respond to a received IMS request addressed to an IP address within the associated IP address domain by returning an indication that the associated terminating UE is unreachable.

11. Apparatus according to claim 1 and being configured, upon receipt of a SIP request addressed to an IP address within an associated IP address domain for which no counter currently exists, to establish a counter for that domain and update the counter.

12. Apparatus according to claim 10, wherein one or more of said packet gateways utilize IPv4, and said IP address domains associated with those packet gateways are respective IPv4 subaddresses, the apparatus being preconfigured to store the lowest subaddress level that IPv4 addresses are allocated from by the packet gateway.

13. Apparatus according to claim 10, being configured, upon receipt of a SIP message at the P-CSCF from a UE, to determine whether or not the UE is allocated an IP address within an IP address domain for which a counter has reached a predefined threshold and, if yes, then reset the counter and, if not, take no action with regard to any associated counter.

14. Apparatus according to claim 10, being configured to indicate failure to deliver a SIP request by expiry of a T2 timer.

15. Apparatus according to claim 10, being configured to start a timer, Tx, upon sending of a SIP request to a UE, the timer having a predefined expiry value, subsequently receive a SIP BYE from the sender of the SIP request and, if at that time the timer, Tx, has expired, use this as an indication of failure to deliver the SIP request.
